(19) United States
(12) Patent Application Publication
(10) Pub. No.: US 2025/0037038 A1
(43) Pub. Date: Jan. 30, 2025

(54) INFORMATION PROCESSING APPARATUS, METHOD AND NON-TRANSITORY COMPUTER READABLE MEDIUM

(71) Applicant: KABUSHIKI KAISHA TOSHIBA, Tokyo (JP)

(72) Inventors: Yuichi KATO, Moriya Ibaraki (JP); Kentaro TAKAGI, Yokohama Kanagawa (JP); Kouta NAKATA, Chigasaki Kanagawa (JP)

(73) Assignee: KABUSHIKI KAISHA TOSHIBA, Tokyo (JP)

(21) Appl. No.: 18/589,003

(22) Filed: Feb. 27, 2024

(30) Foreign Application Priority Data
Jul. 24, 2023 (JP) 2023-119995

(51) Int. Cl. G06N 20/20

(52) U.S. Cl. CPC G06N 20/20

(57) ABSTRACT

According to one embodiment, the information processing apparatus includes a processor. The processor extracts a plurality of features from a plurality of training data by using a machine learning model. The processor generates a prediction result relating to a task, from the training data and teaching data corresponding to the training data. The processor calculates a similarity between features with respect to the plurality of features. The processor updates a parameter of the machine learning model, based on the prediction result and the similarity, in such a manner that the features become farther from each other.

### CROSS-REFERENCE TO RELATED APPLICATION

This application is based upon and claims the benefit of priority from prior Japanese Patent Application No. 2023-119995, filed Jul. 24, 2023, the entire contents of which are incorporated herein by reference.

### FIELD

Embodiments described herein relate generally to an information processing apparatus, method and non-transitory computer readable medium.

### BACKGROUND

In machine learning, the human cost for teaching data generation can be reduced by training a model by self-supervised learning that uses an automatically given teaching signal, without using teaching data that is manually given. Contrastive learning is one of such self-supervised learning methods. In the contrastive learning, a pair of data is generated from one data by data augmentation, and training is executed such that the paired data are made closer to each other as positive examples, and a pair other than positive examples (a pair of negative examples) are made farther from each other. However, since images relating to the pair of positive examples, and images relating to the pair of negative examples, need to be input to an encoder, there a problem that the calculation amount is large.

### BRIEF DESCRIPTION OF THE DRAWINGS

FIG. 1 is a block diagram illustrating an information processing apparatus according to an embodiment.

FIG. 2 is a flowchart illustrating a first operation example of the information processing apparatus according to the embodiment.

FIG. 3 is a diagram illustrating one example of a machine learning model that is used in the first operation example of the information processing apparatus according to the embodiment.

FIG. 4 is a diagram illustrating another example of the machine learning model that is used in the first operation example of the information processing apparatus according to the embodiment.

FIG. 5 is a flowchart illustrating a second operation example of the information processing apparatus according to the embodiment.

FIG. 6 is a diagram illustrating a second example of a network configuration of the machine learning model according to the embodiment.

FIG. 7 is a diagram illustrating an example of a hardware configuration of the information processing apparatus according to the embodiment.

### DETAILED DESCRIPTION

In general, according to one embodiment, the information processing apparatus includes a processor. The processor extracts a plurality of features from a plurality of training data by using a machine learning model. The processor generates a prediction result relating to a task, from the training data and teaching data corresponding to the training data. The processor calculates a similarity between features with respect to the plurality of features. The processor updates a parameter of the machine learning model, based on the prediction result and the similarity, in such a manner that the features become farther from each other.

Hereinafter, an information processing apparatus, method and non-transitory computer readable medium according to the embodiment are described in detail with reference to the accompanying drawings. In the embodiment below, it is assumed that parts with identical reference signs perform similar operations, and an overlapping description is omitted unless where necessary.

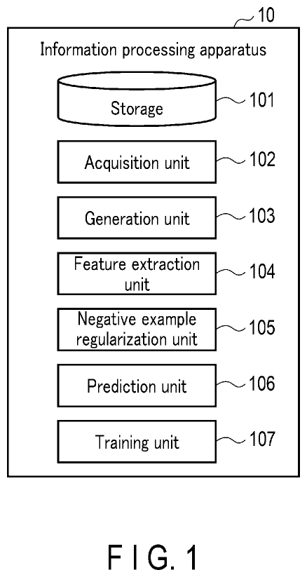

An information processing apparatus according to the first embodiment is described with reference to a block diagram of FIG. 1.

An information processing apparatus 10 according to the embodiment includes a storage 101, an acquisition unit 102, a generation unit 103, a feature extraction unit 104, a negative example regularization unit 105, a prediction unit 106, and a training unit 107.

The storage 101 stores a machine learning model, training data, teaching data, and the like. The machine learning model is, for example, an auto-encoder in which models called an encoder and a decoder are combined. Specifically, a ViT (Vision Transformer) is assumed as the encoder. Note that, aside from the ViT, any type of model is applicable if the model is a network model used in feature extraction or dimension compression, such as a deep network model including a convolutional neural network (CNN) such as ResNet.

As the decoder, it is assumed that a network model constituted by a Transformer block is used. Note that as the decoder, aside from the Transformer block, any type of model is applicable if the model is a network model that can generate restored data from a feature extracted by the encoder, such as an MLP (Multi-Layer Perceptron) or a convolutional neural network. The training data is data for training a machine learning model to be described later. The teaching data is correct-answer data for the training data. In the present embodiment, a case in which training data is images is assumed, but the embodiment is not limited to this. For example, use may be made of one-dimensional time-series data such as control signal data, speech data, natural language data, music data and sensor values, or data of two or more dimensions, other than images, such as sign data, log data, moving picture data, table data, and transaction data.

The acquisition unit 102 acquires training data and teaching data.

The generation unit 103 generates a plurality of partial training data from one training data, by cutting out a part of the training data. In addition, the generation unit 103 executes a data augmentation process on a plurality of training data.

The feature extraction unit 104 extracts a plurality of features from a plurality of training data by using the machine learning model.

The negative example regularization unit 105 calculates a similarity between features with respect to the plurality of features.

The prediction unit 106 generates a prediction result relating to a task, from the training data and the teaching data corresponding to the training data.

Based on the prediction result and the similarity, the training unit 107 updates parameters of the machine learning model in such a manner that the features become father from each other. The parameters of the machine learning model include, for example, a weight and a bias of a network.

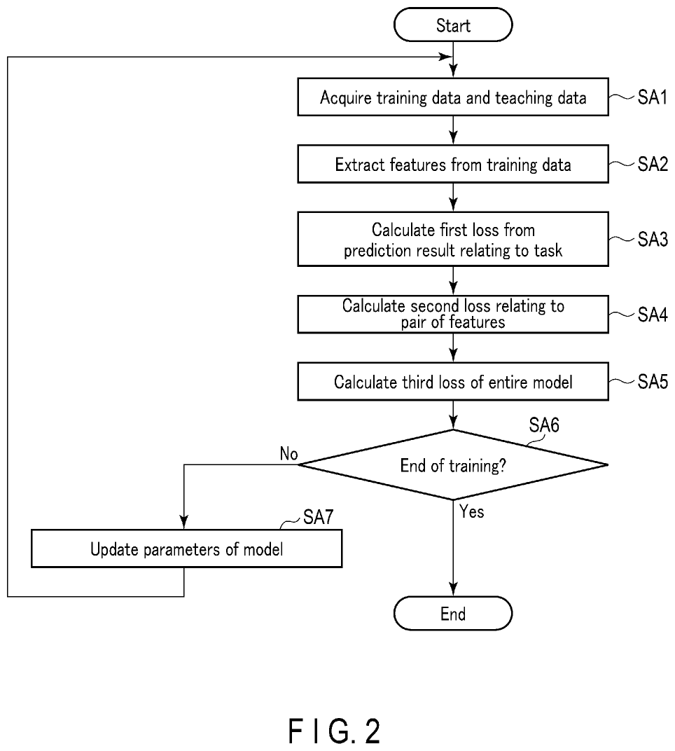

Next, a first operation example of the information processing apparatus 10 according to the embodiment is described with reference to a flowchart of FIG. 2. Here, a case is assumed in which an auto-encoder is used as the machine learning model.

In step SA1, the acquisition unit 102 acquires training data and teaching data from the storage 101.

In step SA2, the feature extraction unit 104 extracts features from the training data. For example, by inputting the training data to the encoder, the feature extraction unit 104 may extract features relating to the training data.

In step SA3, the prediction unit 106 generates a prediction result relating to a task by using the features and the teaching data. For example, in the case of a classification task, by inputting the features to the decoder, an output relating to a classification from the decoder is generated as a prediction result. Further, using a loss function indicated by equation (1), a first loss Lₜₐₛₖ relating to a difference between the prediction result and the training data input to the feature extraction unit 104 is calculated.

$${L}_{task} = \frac{1}{N} {\sum }_{j}^{N} {‖ {y}_{j} - {x}_{j} ‖}^{2} \qquad ( 1 )$$

Here, N is the number of data, yⱼ is a prediction result relating to j-th training data, and xⱼ is j-th training data.

In step SA4, with respect to a plurality of features calculated in step SA3, the negative example regularization unit 105 calculates a loss relating to a pair of features, that is, a second loss relating to a similarity between features. Specifically, using a loss function indicated by equation (2), a second loss L_{reg} may be calculated.

$${L}_{reg} = \frac{1}{N} {\sum }_{i}^{N} - log \frac{exp ( {z}_{i} \cdot {z}_{i} / τ )}{{\sum }_{k}^{N} exp ( {z}_{i} \cdot {z}_{k} / τ )} \qquad ( 2 )$$

Here, Zᵢ is a feature of each data, and τ is a temperature parameter that may be set to a freely chosen value. The loss function indicated by equation (2) is a function with a value that becomes smaller as the similarity between features becomes smaller. In other words, the loss function indicated by equation (2) is a loss function for updating a weight in such a manner that the features become farther from each other. Note that the loss function used by the negative example regularization unit 105 is not limited to equation (2), and equation (3), for example, may be used.

$${L}_{reg} = \frac{1}{{N}^{2}} {\sum }_{i , j}^{N} {( ( I - {zz}^{T} ) ⊗ ( I - {zz}^{T} ) )}_{ij} \qquad ( 3 )$$

Here, I is an identity matrix, z is a matrix of features, and z^{T} is a transposed matrix of features. In addition, a sign indicated by a cross in a circle is a tensor product.

Note that equation (4) may be used as the loss function of the negative example regularization unit 105. Needless to say, aside from these equations of the loss function, any function may be adopted if the function is a loss function that can train a model such that features become farther from each other.

$$L = \frac{1}{{N}^{2}} {\sum }_{i , j}^{N} {\vert I - {zz}^{T} \vert}_{ij} \qquad ( 4 )$$

In step SA5, using the first loss Lₜₐₛₖ and the second loss L_{reg}, the training unit 107 calculates a third loss L that is a loss of the entire model. Specifically, the third loss L may be calculated by using, for example, equation (5).

$$L = {L}_{task} + α \cdot {L}_{reg} \qquad ( 5 )$$

Here, α is a freely chosen real number, and is a parameter for weighting the second loss L_{reg} that is calculated by the negative example regularization unit 105.

In step SA6, the training unit 104 determines whether the training of the machine learning model has ended or not. As regards the determination as to whether the training has ended or not, for example, if the loss value of the loss function of equation (5) is equal to or less than a threshold, it may be determined that the training has ended. Alternatively, if the width of decrease of the loss value has converged, it may be determined that the training has ended. Besides, if a predetermined epoch number of processes has ended, it may be determined that the training has ended. If the training ended, the process is terminated, and if the training has not ended, the process goes to step SA7.

In step SA7, the training unit 104 updates the parameters of the machine learning model (here, the encoder), for example, by a gradient descent method or an error backpropagation method, in such a manner that the loss value becomes minimum. Specifically, the training unit 104 updates the parameters, such as a weight and a bias of the neural network relating to, for example, the encoder. After updating the parameters, the process returns to step SA1, and the training of the machine learning model is continued by using new training data. If the training is finally completed, the training of the machine learning model is finished, and a trained model is generated. The trained model after the training may be stored, for example, in the storage 101 of the information processing apparatus 10.

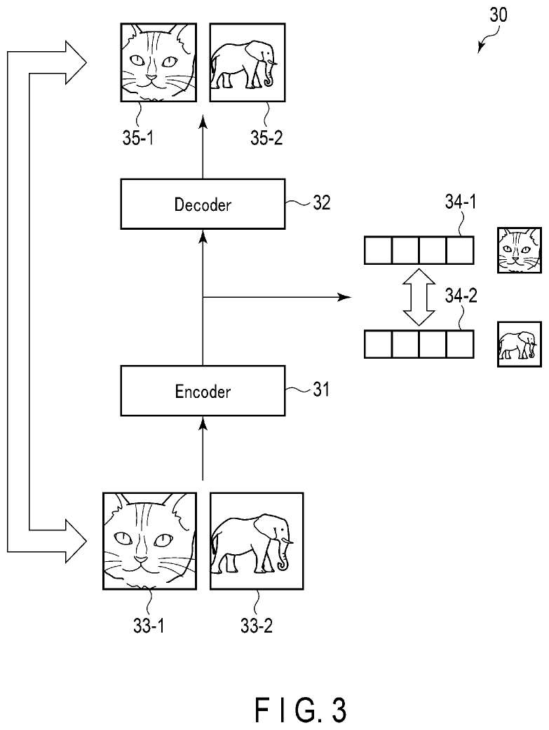

Next, referring to FIG. 3, a description is given of one example of the machine learning model used in the first operation example of the information processing apparatus 10 according to the embodiment.

A machine learning model 30 illustrated in FIG. 3 is an example of an auto-encoder, and includes an encoder 31 and a decoder 32. In the auto-encoder illustrated in FIG. 3, a prediction task of predicting an original image is assumed. The encoder 31 and the decoder 32 may have a contrastive configuration, or may have a non-contrastive configuration. In addition, the model size of the machine learning model of the decoder 32 may be designed to be smaller than the model size of the encoder 31. Thereby, the calculation amount can be reduced. Note that in the description below, in a case where particular distinction is not needed, such descriptions as “input image 33”, “feature 34” and “output image 35” are used.

In the example of FIG. 3, input images 33 are input to the encoder 31, and features are extracted in the encoder 31. Here, as the input images 33, an input image 33-1 of a cat and an input image 33-2 of an elephant are input. In the encoder 31, each of the input image 33-1 and input image 33-2 is subjected to a convolutional process, and a feature 34-1 relating to the input image 33-1 and a feature 34-2 relating to the input image 33-2 are extracted. Here, by the processing of the negative example regularization unit 105, the second loss between the feature 34-1 and the feature 34-2 is calculated by the loss function of, for example, any one of the above-described equations (2) to (4), which can execute training in such a manner that features become farther from each other. Specifically, in the information processing apparatus 10 according to the embodiment, unlike the contrastive learning in which training is executed such that positive examples are made closer to each other and negative examples are made farther from each other, training is executed such that all features are made farther from each other. Thereby, there is no need to prepare positive examples, and the cost can be reduced.

On the other hand, the feature 34-1 and feature 34-2 that are output from the encoder 31 are input to the decoder 32. The decoder 32 outputs such an output image 35-1 and an output image 35-2 as to reproduce the input image 33-1 and input image 33-2. By the processing of the prediction unit 106, the first loss is calculated by the loss function of, for example, the above-described equation (1), which can execute such training as to decrease the difference between the output image 35 and the input image 33.

Note that the classification task may be solved by using teaching data.

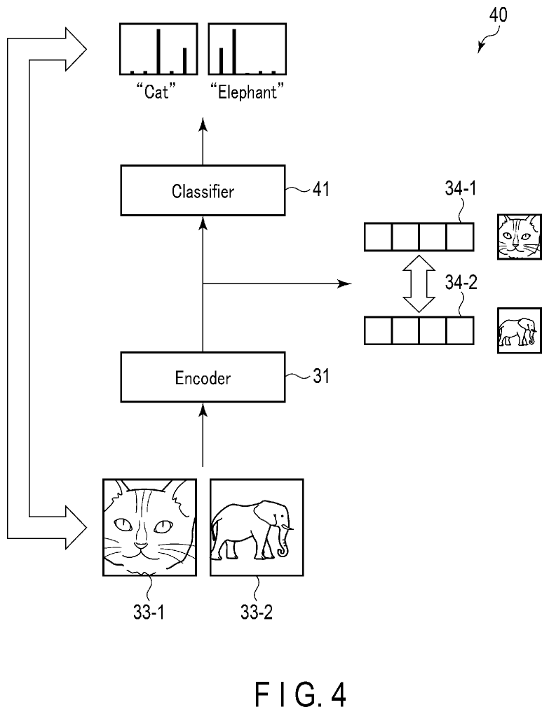

Referring to FIG. 4, a description is given of another example of the machine learning model used in the first operation example of the information processing apparatus 10 according to the embodiment.

In a machine learning model 40 illustrated in FIG. 4, a classifier 41, instead of the decoder illustrated in FIG. 3, is connected to the encoder 31. For example, the prediction unit 106 outputs, instead of the output image 35, a probability value of the classification task as a prediction value from the classifier 41. In addition, the model 40 may be trained in such a manner as to solve the classification task, by a loss function relating to, instead of the first loss, a cross entropy error between the prediction value and the teaching data. At this time, the prediction unit 106 may use, instead of the decoder, an MLP constituted by one layer or two layers as the classifier 41.

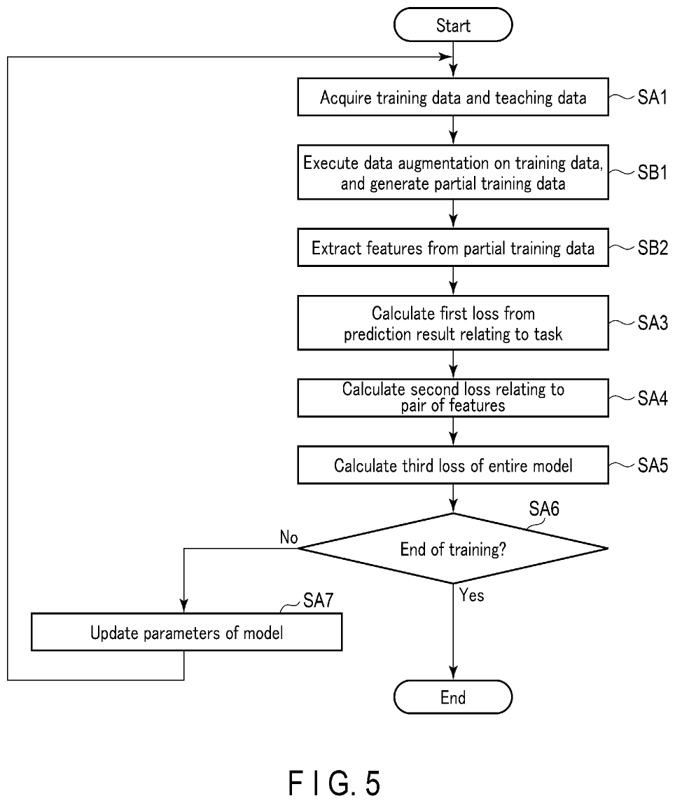

Next, a second operation example of the information processing apparatus 10 according to the embodiment is described with reference to a flowchart of FIG. 5.

Since step SA1, and step SA3 to step SA7 are similar to those in FIG. 2, a description thereof is omitted.

In step SB1, the generation unit 103 generates a plurality of partial training data by cutting out a part of the training data. For example, partial images, which are generated by cropping a plurality of partial areas such as an upper right portion and a lower left portion of one image data, may be used as the partial training data. Note that the generation unit 103 may execute a data augmentation process on the training data. By the data augmentation process, aside from the crop images, a plurality of data can be generated based on one image, such as by an image division process (patch division), a reversing process, a rotating process, a noise adding process, and a combination thereof.

In step SB2, the feature extraction unit 104 extracts features from the partial training data.

In this manner, by using the partial training data, the calculation amount in the encoder can be reduced.

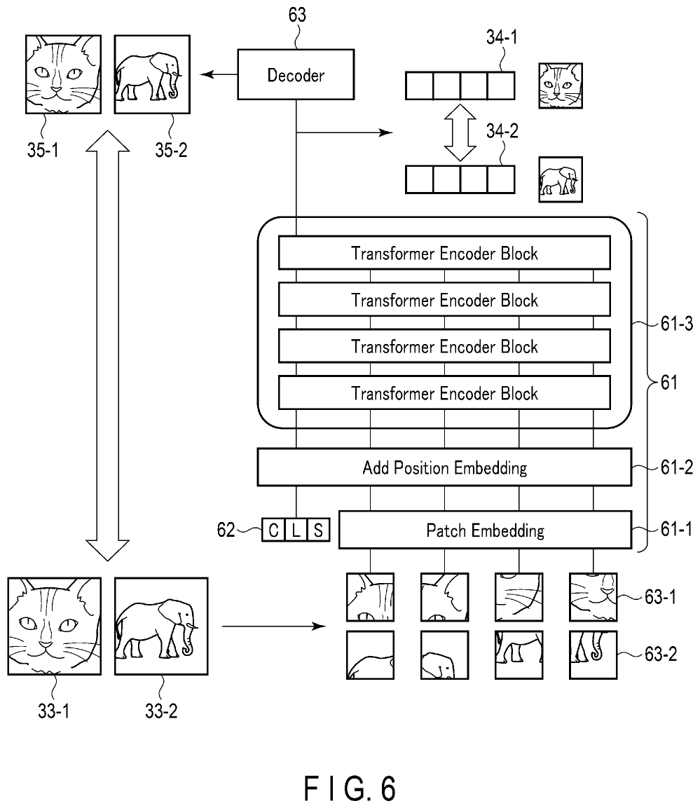

Next, referring to FIG. 6, a description is given of an example of the machine learning model used in the second operation example of the information processing apparatus 10 according to the embodiment.

In the example of FIG. 6, as an encoder 61, a model using a ViT (Vision Transformer) is used. The ViT is configured such that a plurality of Transformer Encoder blocks are stacked.

In the ViT, an input image 33 is first divided into patch images by a Patch Embedding 61-1. Next, by an Add Position Embedding 61-2, in regard to the patch image, position information indicating at which position in the entire image the patch image is located, and a class token capable of learning, are embedded. As regards the class token 62, since a token generally used in the ViT is assumed, a detailed description is omitted. Note that the Patch Embedding 61-1 and Add Position Embedding 61-2 may not be assembled in the encoder 61, and may be executed as a process different from the encoder, that is, as a pre-process.

Thereafter, the patch image in which the position information is embedded is processed by a plurality of Transformer Encoder blocks 61-3, and a feature 34 is extracted. Note that since the Transformer Encoder block 61-1 itself is a process used in a general ViT, a detailed description thereof is omitted here.

Like the case of FIG. 3, by the processing of the negative example regularization unit 105, as regards the features 34 output from the encoder 61, the encoder 61 is trained by using the loss function that can execute such training that all features become farther from each other. As a result, the second loss L_{reg} is calculated. As regards the decoder 63, like the case of FIG. 3, the first loss Lₜₐₛₖ may be calculated by using such a loss function that the difference between the output image 35 and the input image 33 becomes smaller, or such a loss function that the difference between the output image 35 and the image before the data augmentation of the input image 33 becomes smaller.

Thereafter, the machine learning model of FIG. 6 may be trained by using the loss function relating to the loss L of the entire model, which is indicated, for example, in equation (5).

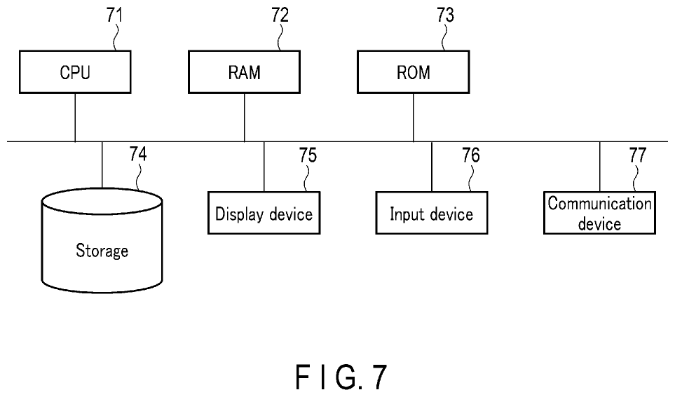

Next, an example of a hardware configuration of the information processing apparatus 10 according to the above-described embodiment is illustrated in a block diagram of FIG. 7.

The information processing apparatus 10 includes a CPU (Central Processing Unit) 71, a RAM (Random Access Memory) 72, a ROM (Read Only Memory) 73, a storage 74, a display device 75, an input device 76, and a communication device 77, and these components are connected by a bus.

The CPU 71 is a processor that executes an arithmetic process and a control process, or the like, in accordance with a program. The CPU 71 uses a predetermined area of the RAM 72 as a working area, and executes the above-described processes of the respective units of the information processing apparatus 10 in cooperation with programs stored in the ROM 73 and storage 74, or the like. Note that the processes of the information processing apparatus 10 may be executed by one processor, or may be executed by a plurality of processors in a distributed manner.

The RAM 72 is a memory such as an SDRAM (Synchronous Dynamic Random Access Memory). The RAM 72 functions as the working area of the CPU 71. The ROM 73 is a memory that stores programs and various information in a non-rewritable manner.

The storage 74 is a device that writes and reads data to and from a magnetic recording medium such as an HDD (Hard Disk Drive), a recording medium by a semiconductor such as a flash memory, a magnetically recordable storage medium such as an HDD, or an optically recordable storage medium. The storage 74 writes and reads data to and from the storage medium in accordance with control from the CPU 71.

The display device 75 is a display device such as an LCD (Liquid Crystal Display). The display device 75 displays various information, based on a display signal from the CPU 71.

The input device 76 is an input device such as a mouse and a keyboard, or the like. The input device 76 accepts, as an instruction signal, information that is input by a user's operation, and outputs the instruction signal to the CPU 71.

The communication device 77 communicates, via a network, with an external device in accordance with control from the CPU 71.

According to the above-described embodiment, a prediction result relating to a task is generated from training data and teaching data, a similarity between features of the training data is calculated, a loss function is set, based on the prediction result and the similarity, in such a manner that the features become farther from each other, and parameters of a machine learning model is updated based on a loss value of the loss function.

Thereby, there is no need to generate a positive example, or to execute calculation by inputting a pair between training data and the positive example and a pair between training data and a negative to the encoder, as in general contrastive learning. In addition, there is no need to generate a mask image (an image or a patch image in which a part of an input image is masked), or to input the mask image to the encoder, as in a Masked Auto Encoder (MAE). Thus, the calculation cost at the time of training the machine learning model can be reduced. Moreover, in the machine learning model, the calculation amount can further be reduced by making the model size of the decoder smaller than the model size of the encoder.

Here, a case is assumed in which the model size of the decoder is sufficiently smaller than the model size of the encoder, and the calculation amount of the decoder can be ignored. A neural network is used as the machine learning model, and an error backpropagation method that is a general training method thereof is used. In this case, if the calculation amount of forward propagation of the encoder per data is defined as C, in the error backpropagation method, the calculation cost becomes 2C in total, i.e., the calculation amount C relating to backpropagation and the calculation amount C relating to differential calculation. Furthermore, in the contrastive learning, since both the pair relating to the positive example and the pair relating to the negative example are input to the encoder, the calculation amount of the forward propagation becomes 2C, and, as a result, the calculation amount of about 4C in total per training data is necessary.

On the other hand, as regard the calculation cost at the time of training by the information processing apparatus 10 according to the present embodiment, since the calculation relating to pairs of positive examples is not necessary, it can be said that the calculation cost of the information processing apparatus 10 according to the present embodiment is about 3C. Thus, compared to the contrastive learning, the calculation amount can be reduced by 25% per training data.

The instructions indicated in the processing procedures illustrated in the above embodiment can be executed based on a program that is software. A general-purpose computer system may prestore this program, and may read in the program, and thereby the same advantageous effects as by the control operations of the above-described information processing apparatus can be obtained. The instructions described in the above embodiment are stored, as a computer-executable program, in a magnetic disc (flexible disc, hard disk, or the like), an optical disc (CD-ROM, CD-R, CD-RW, DVD-ROM, DVD±R, DVD±RW, Blu-ray (trademark) Disc, or the like), a semiconductor memory, or other similar storage media. If the storage medium is readable by a computer or an embedded system, the storage medium may be of any storage form. If the computer reads in the program from this storage medium and causes, based on the program, the CPU to execute the instructions described in the program, the same operation as the control of the information processing apparatus of the above-described embodiment can be implemented. Needless to say, when the computer obtains or reads in the program, the computer may obtain or read in the program via a network.

Additionally, based on the instructions of the program installed in the computer or embedded system from the storage medium, the OS (operating system) running on the computer, or database management software, or MW (middleware) of a network, or the like, may execute a part of each process for implementing the embodiment.

Additionally, the storage medium in the embodiment is not limited to a medium that is independent from the computer or embedded system, and may include a storage medium that downloads, and stores or temporarily stores, a program that is transmitted through a LAN, the internet, or the like.

Additionally, the number of storage media is not limited to one. Also when the process in the embodiment is executed from a plurality of storage media, such media are included in the storage medium in the embodiment, and the media may have any configuration.

Note that the computer or embedded system in the embodiment executes the processes in the embodiment, based on the program stored in the storage medium, and may have any configuration, such as an apparatus composed of any one of a personal computer, a microcomputer and the like, or a system in which a plurality of apparatuses are connected via a network.

Additionally, the computer in the embodiment is not limited to a personal computer, and may include an arithmetic processing apparatus included in information processing equipment, a microcomputer, and the like, and is a generic term for devices and apparatuses which can implement the functions in the embodiment by programs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising a processor configured to:
extract a plurality of features from a plurality of training data by using a first machine learning model;
generate a prediction result relating to a task, from the training data and teaching data corresponding to the training data;
calculate a similarity between features with respect to the plurality of features; and
update a parameter of the first machine learning model, based on the prediction result and the similarity, in such a manner that the features become farther from each other.

2. The apparatus according to claim 1, wherein the processor is further configured to:
generate a plurality of partial training data from one training data; and
extract the features by using the plurality of partial training data.

3. The apparatus according to claim 1, wherein the prediction result is generated by a second machine learning model, and
a size of the second machine learning model is smaller than a size of the first machine learning model.

4. The apparatus according to claim 1, wherein the task is a process of predicting the training data in which the features are extracted.

5. The apparatus according to claim 1, wherein the processor is further configured to execute a data augmentation process on the plurality of training data, and
the task is a process of predicting the training data before execution of the data augmentation process.

6. The apparatus according to claim 1, wherein the processor is configured to update the parameter of the first machine learning model, in such a manner that a loss value calculated by a loss function is minimized, the loss function outputting a value that becomes smaller as the similarity between the features becomes smaller.

7. An information processing method comprising:
extracting a plurality of features from a plurality of training data by using a machine learning model;
generating a prediction result relating to a task, from the training data and teaching data corresponding to the training data;
calculating a similarity between features with respect to the plurality of features; and
updating a parameter of the machine learning model, based on the prediction result and the similarity, in such a manner that the features become farther from each other.

8. A non-transitory computer readable medium including computer executable instructions, wherein the instructions, when executed by a processor, cause the processor to perform a method comprising:
extracting a plurality of features from a plurality of training data by using a machine learning model;
generating a prediction result relating to a task, from the training data and teaching data corresponding to the training data;
calculating a similarity between features with respect to the plurality of features; and
updating a parameter of the machine learning model, based on the prediction result and the similarity, in such a manner that the features become farther from each other.
